(19) United States
(12) Patent Application Publication
(10) Pub. No.: US 2024/0013934 A1
(43) Pub. Date: Jan. 11, 2024

(54) ASYMMETRIC DRIVE OF INERTIAL FUSION TARGETS

(71) Applicants: XCIMER ENERGY, INC., Redwood City, CA (US); University of Rochester, Rochester, NY (US)

(72) Inventors: Cliff Avery Thomas, Pittsford, NY (US); Conner Daniel Galloway, Foster City, CA (US)

(21) Appl. No.: 18/218,512

(22) Filed: Jul. 5, 2023

Related U.S. Application Data
(60) Provisional application No. 63/359,730, filed on Jul. 8, 2022.

(51) Int. Cl. G21B 1/23; G21B 1/19

(52) U.S. Cl. CPC G21B 1/23; G21B 1/19

(57) ABSTRACT

An inertial confinement fusion (ICF) system includes a target that is imploded by a driver having at least one laser source. The target includes a fusion fuel layer, an ablator layer, and a corona-forming layer. At least one laser source is configured to illuminate the target with two substantially opposed beams in two or more stages. Such illumination results in ignition of the fusion fuel layer. Other embodiments are described and claimed.

This application claims the benefit of priority of U.S. Provisional Patent Application No. 63/359,730, filed on Jul. 8, 2022, titled “Asymmetric Drive of Inertial Fusion Targets,” which is incorporated herein by reference in its entirety to provide continuity of disclosure.

### GOVERNMENT SUPPORT

This invention was made with government support under DE-NA0003856, DE-NA0003868 and RFA2022a-61 awarded by the Department of Energy. The government has certain rights in the invention.

### BACKGROUND

This invention is in the field of inertial confinement fusion (ICF) systems. ICF systems may be used for research purposes in high-energy physics, and are being investigated for use in energy production.

Some ICF systems include a spherical component of fusion fuel, which is usually surrounded by another spherical shell termed the ablator. This assembly is commonly referred to as a “target” or “fuel pellet” among other terms known to the skilled artisan. The target is typically held inside a containment chamber at a low pressure relative to ambient. A high-power source of energy, such as a laser, is used to symmetrically heat the ablator, which causes it to rapidly expand outwards. A reactive force drives the fuel inwards, compressing and heating it so as to reach the temperatures and densities needed for fusion. If the areal density of the compressed fuel is sufficiently high to slow and stop fusion products including alpha particles, then the temperature and reaction rate may further increase. When conditions are adequate, this process will initiate “runaway” or “propagating burn” of the fusion fuel, which is only confined by the inertia of the compressed fuel and other target material itself. High pressures cause the fuel to expand, disassemble, and cool, which eventually quenches further reactions.

The process of compressing and heating the fuel is sometimes called an “implosion”, and successfully achieving runaway burn and/or significant energy production is sometimes called “ignition”. Not all targets used for research purposes are designed or expected to achieve ignition and/or runaway burn.

Whatever their purpose, the operation of these targets may depend on a variety of factors. Hydrodynamic instabilities can magnify imperfections intrinsic to target fabrication and/or energy deposition. The amplitude of flaws can grow large enough to disrupt the symmetry of the implosion, which has the potential to reduce compression, and the peak temperatures and reaction rates.

In some ICF systems, the laser is configured to directly energize the ablator symmetrically from all directions using a multitude of beams numbered in the many tens or hundreds. This approach is typically called “direct-drive”. In this case, any non-uniformities in the laser due to optical phenomena and/or variations in the energy per beam can be sources of asymmetry. Since the ablation pressure scales with laser intensity, it is generally assumed the incident flux must be uniform to a few percent to achieve adequate implosion symmetry. The design of some ICF systems may be primarily influenced by the associated requirements in the laser. In certain systems, the target may be surrounded by a container called a hohlraum, and suspended inside. A cylindrical hohlraum will often have entrance ports on both ends. In operation, a multitude of laser beams are fired into the hohlraum through the entrance ports, which illuminate and energize a series of spots on the inner wall of the hohlraum. These spots emit x-rays, which subsequently fill the hohlraum and ablate and implode the suspended target in the same manner described above. The geometry of this configuration and the process of laser absorption and x-ray emission has the potential to smooth variations in the optical quality or energy of the laser beams. These systems are said to use “indirect-drive”.

Both direct-drive (DD) and indirect-drive (ID) ICF systems have pros and cons. ID can in principle achieve more uniform target illumination due to the significant decoupling of the laser geometry and fuel pellet via x-rays. This approach requires the use of a hohlraum, and only a small fraction of the driver can be coupled to the fuel pellet. By contrast, DD systems can be more susceptible to non-uniformity in the laser beams, but are much more efficient at coupling energy to the fusion fuel. If aspects of symmetry control were to be improved for systems based on DD, then they might be preferred to ID.

Beneficial aspects of ID and DD also have the potential to be combined. Concepts of this type may be termed a “hybrid”. As known to the skilled artisan, the conventional implementations of both are largely incompatible. ID targets involve a hohlraum, which is typically driven through a small number of ports having a small solid angle relative to the fuel pellet. By contrast, DD targets are commonly driven by a large number of beams in 4π (i.e., the solid angle of a complete sphere). As a result, all existing facilities primarily pursue implementations of indirect drive, or direct drive, individually.

### SUMMARY

Some embodiments of this invention are directed at ICF systems involving targets that are imploded by a driver having a small number of beams relative to existing DD ICF systems. In some embodiments, a target contains a fuel layer surrounded by a corona-forming mechanism, and in some embodiments, the purpose of this mechanism is to actively control and compensate for sources of asymmetry present in the drive. In operation of some embodiments, one or more initial laser pulses of a first pulse set are used to convert the corona-forming mechanism into an underdense corona, and one or more subsequent laser pulses of a second pulse set are used to directly energize this corona. The optical characteristics of the one or more subsequent laser pulses of the second pulse set may be configured to result in a primarily symmetric implosion of the fuel layer in the target, even if the subsequent laser pulse(s) deliver energy to the target asymmetrically; for example and not by way of limitation, from a limited number of directions. In some embodiments, the corona-forming mechanism and laser pulse(s) are used together to optimize for thermal smoothing within an ablator layer and a corona-forming layer of the corona-forming mechanism, and thereby produce a more uniform implosion of the fuel layer.

### BRIEF DESCRIPTION OF THE DRAWINGS

FIGS. 1A and 1B show illustrations of an inertial confinement fusion system according to some embodiments.

FIG. 2 shows a flowchart of a method of achieving implosion of an inertial confinement fusion target according to some embodiments.

FIGS. 3A and 3B show illustrations of an inertial confinement fusion target including a hohlraum according to some embodiments.

FIG. 4 shows an illustration of an embodiment involving shimming of a corona-forming layer and an ablator layer in thickness.

FIG. 5 illustrates a spatial profile of a laser beam according to some embodiments of the invention.

### DETAILED DESCRIPTION

Independent of whether lasers or x-rays are used to drive an ablator, the interaction of either with the target quickly forms a surrounding plasma. This plasma is hot and luminous, and low density, and will commonly be termed a “corona”. The mass in the corona will absorb incident laser light or x-rays volumetrically and adjust aspects of energy deposition versus time. Typically, the corona starts as a thin shell and will later become a thick annulus. In the case of the latter, the corona has the potential to integrate imperfections in energy deposition over a large volume. Nonetheless, in conventional ICF targets, the material that forms the corona is not typically used to engineer aspects of laser or x-ray absorption, or thermal conduction, so as to mitigate sources of asymmetry.

To minimize asymmetries in conventional implementations of direct drive, the target will typically be illuminated by a large number of beams arrayed in 4π relative to the target. For the same reason, the laser spots will usually have radii that are similar to a radius of the target. The goal of these ‘features’ is to avoid the seeding of perturbations that may compromise the implosion. However, illumination in 4π by large laser spots is known to exacerbate mechanisms that scatter laser light (e.g., cross-beam energy transfer, or CBET) and limit the energy that can be coupled to the fusion fuel. Typically, targets using direct drive are not explicitly designed to use absorption across an extended corona to attenuate non-uniformities in the incident flux, as might be associated with asymmetric illumination geometries and/or small laser spots.

A multitude of beams can pose significant engineering challenges for a reactor, as each must pass through entrance ports in a containment chamber holding the target. Packaging these ports, protecting optics, and accommodating the other requirements of the reactor is expected to increase the expense and difficulty of realizing these systems. Even for a multitude of beams, the requirements for beam-to-beam uniformity impose significant constraints on the integrated system.

Indirect-drive may allow for implosions with improved symmetry by using a hohlraum to smooth beam-to-beam variations. These benefits come with a cost; a substantial fraction of the total energy in the driver must be absorbed in the walls of the hohlraum and/or emitted out the hohlraum entrance ports as x-rays. Ideally, the energy of the driver would be coupled to the fusion fuel with greater efficiency. Concepts that make DD more compatible with the standard geometry of ID may enable an effective hybrid.

Some embodiments of this invention are intended to provide adequate implosion symmetry and uniformity while maintaining the efficiency of direct-drive, mitigating losses due to scattering, and permitting the use of limited laser geometries, such as those involving just two substantially opposed beams (i.e., illuminating the target from two opposite directions). The skilled artisan will readily appreciate that these opposed beams may each be a single beam, and/or many beams overlapped in a small solid angle, so as to behave similarly to a single beam. Implosion symmetry would normally be inadequate in these scenarios. As used herein, a small solid angle has a meaning that is well understood in the art. For example, a solid angle can be small when the angle represents or subtends a small fraction of the sky (in 4π) from the perspective of a target. Such fraction may be less than 50% of the full sky, e.g., less than 20% of 4π. In an embodiment, the small fraction is less than 1% of 4π. For example, the small fraction may be less than 0.1%, e.g., less than 0.01% of 4π. In a particular embodiment provided by way of example and not limitation, the solid angle represents or subtends 0.001% to 0.0.005%, e.g., 0.002%, of 4π. Such solid angle can correspond, for example, to an optical area of 1 square meter at a 50 meter stand off between the laser source and the target. It is understood however, that the small solid angle may be up to and including 4π.

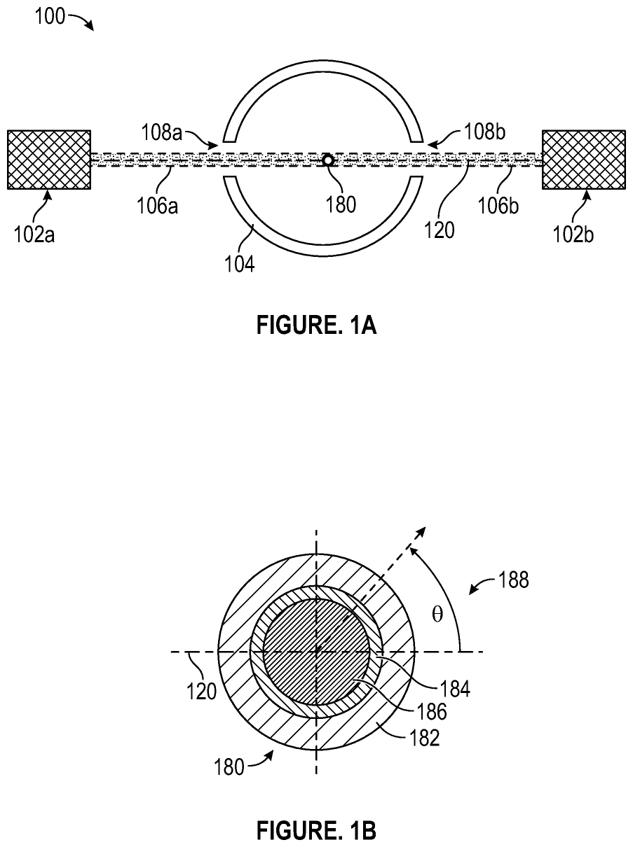

Referring to FIGS. 1A and 1i, in some embodiments, these challenges are overcome by targets and systems that control the properties of the coronal plasma surrounding the fuel pellet. A substantial fraction of the corona is at low density, which allows the volumetric propagation and absorption of incoming laser beams. An illustration of a first embodiment is shown in FIGS. 1A and 1B, depicting inertial confinement fusion (ICF) system 100. Referring to FIG. 1A, ICF system 100 includes containment chamber 104, which is illustrated as spherical, but could be other shapes including a cylinder by way of example and not limitation.

The ICF system 100 can perform a method of inertial confinement fusion. By way of introduction, the method of inertial confinement fusion can include several stages of an implosion, each of which can include generation of a single laser pulse or several laser pulses. The laser pulse(s) of the stages may be differentiated and/or grouped by their occurrence in time and/or by a mode of operation of the laser pulse(s). For example, as described further below, one or more laser pulses in a first stage can operate to generate an underdense corona. By contrast, one or more laser pulses in a second stage can operate to interact with the underdense corona to generate a sufficiently symmetric implosion to ignite a fuel. The one or more laser pulses of the first stage can be termed a “first pulse set.” Similarly, the one or more laser pulses of the second stage may be termed a “second pulse set.” Hence, care has been taken to clarify that the first pulse set and the second pulse set may each include a single laser pulse or a train of laser pulses having similar characteristics and grouped in time to perform a predetermined stage of the implosion.

In a first stage of an implosion, two substantially opposed laser sources 102a and 102b generate a first pulse set. The first pulse set includes one or more pulses of light that propagate along paths 106a and 106b and enters containment chamber 104 through two entrance ports 108a and 108b to illuminate a target 180. The first pulse set can include an initial laser pulse, which can be represent the entire first pulse set or may be one of several first laser pulses. Referring to FIG. 1B, target 180 includes a corona-forming layer 182, an ablator layer 184, and a fuel layer 186. Target 180 is positioned in containment chamber 104 and is aligned with laser sources 102a and 102b and beam paths 106a and 106b.

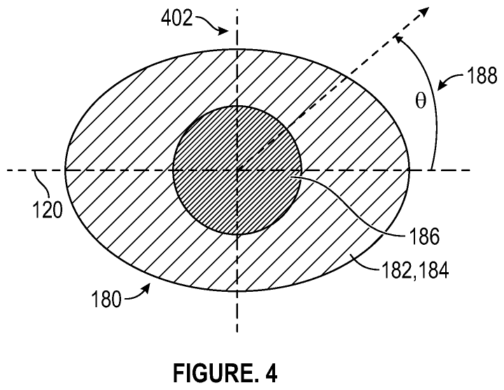

The corona-forming layer 182 may be a mixture of elements having different atomic numbers. Materials may include Hydrogen, Carbon, Silicon, Tungsten, and Gold, by way of example and not limitation. In this way, the absolute and relative absorption of laser light and/or x-rays can be adjusted while managing other aspects of design. In some embodiments of the invention, the corona-forming layer 182 is composed of Carbon and Gold, and Silicon, to speed the generation of a uniform corona, but limit any preheat of the fusion fuel. By choice of the mass density of the corona-forming layer 182, thickness, and the relative fraction of different materials, the corona needed to generate more symmetric implosions is engineered. For the same reasons, the properties of the corona-forming layer 182 may also be graded versus angle 188, relative to axis 120, which is aligned with propagation of beam paths 106a and 106b. Properties that may be graded include species fractions, density, and thickness, by way of example and not limitation. For example, a thickness of the corona-forming layer 182 at an angle 188 of zero degrees (aligned with the axis 120) may be less than a thickness of the corona-forming layer 182 at an angle perpendicular to the axis 120 (along an equatorial plane, similar to the description of FIG. 4, below). The composition of ablator layer 184 is selected to maximize laser absorption and the energy coupled to the fusion fuel layer 186. Layers 182 and 184 may also be combined into a single structure and composed of the same material(s), but are separated in this discussion and composed of differing materials to emphasize aspects of this embodiment of the invention. In operation of this system, the first stage of the implosion involves laser sources 102a and 102b generating an initial pulse of light (of one or more first laser pulses) which traverses beam paths 106a and 106b, which interacts with corona-forming layer 182, and generates an underdense corona surrounding ablator layer 184. A plasma is said to be “underdense” when it allows the propagation and volumetric absorption of the driver, e.g., the laser. Compared to the total energy in the laser system, the energy used in the first laser pulse(s) can be relatively low and may only need to ionize and expand corona-forming layer 182. The properties of the resulting corona are a function of design, and are chosen to compensate and offset for intrinsic sources of asymmetry.

The skilled artisan will appreciate that multiple laser configurations other than two laser sources 102a and 102b may be used to provide beams traveling in beam paths 106a and 106b, for example a single laser source or more than two laser sources may be used.

In a second stage of the implosion, laser sources 102a and 102b generate a second pulse set including one or more additional, or subsequent, laser pulses. Each of the one or more additional laser pulses of light in the second stage may be termed a “second laser pulse.” Accordingly, the second pulse set can include one or more second laser pulses of light in a second set of beams which traverses beam paths 106a and 106b and interacts with the corona formed by the first laser pulse(s) interacting with the corona-forming layer 182.

In some embodiments, electron thermal conduction within the corona smooths the non-uniformity in energy deposited by the second laser pulse(s) of the second stage following the first stage. In some embodiments, a substantially uniform ablation front forms at the outside of ablator layer 184 and propagates inward through ablator layer 184. The geometry of the expanded corona determines the uniformity of the heat flux at the ablation front, and for a given corona, the heat flux may be nearly uniform despite the non-uniformity of the energy deposited by the second laser pulse(s) from laser sources 102a and 102b. The resulting ablation front can be highly symmetric. In some embodiments, the ablation front then propagates through ablator layer 184, imploding and igniting fuel layer 186 as will be appreciated by the skilled artisan. In this manner, by using several laser pulses separated in time, and choosing properties of layers 182 and 184, the energy in the second pulse set from laser sources 102 and, more particularly, the energy in the one or more second laser pulses of the second pulse set in the second stage, can be distributed very uniformly in a large annulus about the fuel layer, taking advantage of properties of the underdense corona. In some embodiments, a train of several subsequent pulses may be generated by the laser sources 102a and 102b. The second laser pulses can be sequential, and the second laser pulses may be absorbed in the plasma corona in a similar way in order to optimize the implosion of the fuel layer.

This embodiment thus utilizes a fundamental insight—an extended underdense corona can be used to absorb an asymmetric laser drive, even a highly asymmetric laser drive, and can still generate a sufficiently symmetric implosion to ignite the fuel. A highly asymmetric laser drive can include two directly opposing beams. A highly asymmetric laser drive can include two directly opposing beams, or any other configuration that might not be expected to result in a symmetric implosion without the benefit of embodiments described herein.

The first laser pulse(s) can form the corona with relatively little energy relative to the total laser energy. Further embodiments explain in detail how the corona can be formed, e.g., using indirect drive. Subsequently, with the corona formed, the implosion of the target can be done via direct-drive style illumination of the expanded corona by two opposed beams, at high energy and higher efficiency, and utilize thermal conduction in the expanded corona to mitigate any asymmetries in energy deposition that arise from the laser illumination geometry.

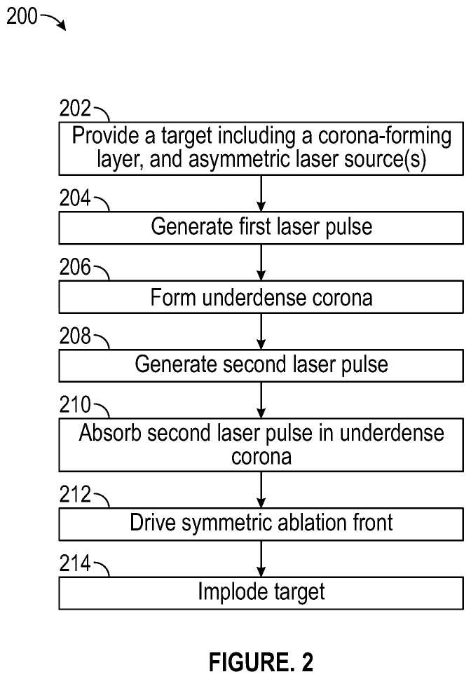

The basic method of operation of some embodiments is illustrated in FIG. 2, showing implosion method 200 to be utilized with the ICF system 100. At operation 202, ICF system 100 is provided including a target 180 including a corona-forming layer 182, and one or more asymmetric laser source, e.g., asymmetric laser sources 102a and 102b. At operation 204, at least two opposing laser beams are generated from asymmetric laser sources 102a and 102b, and are directed to illuminate target 180. At operation 206, the first laser pulse(s) are absorbed in corona-forming layer 182 to form an underdense corona. More particularly, the first laser pulse(s) form an expanded corona. At operation 208, at least two horizontally opposing laser beams are generated from asymmetric laser sources 102a and 102b, or alternative laser sources as will be appreciated by the skilled artisan. At operation 210, the one or more second laser pulses of the second pulse set are absorbed in the underdense corona. More particularly, the second laser pulse(s) following the first laser pulse(s) energizes the expanded corona. At operation 212, laser energy from these laser pulse(s) drives a symmetric ablation front into ablator layer 184. At operation 214, the ablation front implodes target 180 with the characteristics needed to ignite. For example, illumination of the expanded corona can produce a substantially uniform pressure profile on the ablator layer 184 and the fusion fuel layer 186. A pressure profile that generates an implosion with the symmetry needed to ignite can be considered to be substantially uniform.

Designing and utilizing embodiments of this invention involves the balancing of several factors. The designer can utilize any techniques known to those skilled in the art to produce the desired result, including for example and not by way of limitation, the use of particular materials, dimensions, thicknesses, geometries, compositions, and other parameters for target 180. In some embodiments, fuel layer 186 may include for example and not by way of limitation several layers of deuterium-tritium (DT) gas, DT liquids, DT ice, high-Z shells, other high-Z materials, and/or other components. Furthermore, the asymmetric laser sources 102a and 102b can utilize any wavelengths, bandwidths, pulse lengths, pulse shapes, temporal profiles, spatial profiles, or other parameters to achieve the desired result. Several specific points and notable variations are highlighted in some embodiments explained below.

Operation of some embodiments of this invention may rely on electron thermal conduction to symmetrize energy deposited within the corona in operation 210. The symmetry of the resulting ablation front depends on the geometry of the expanded corona at the time of the second laser pulse(s) formed in operation 206. The parameters of the system (e.g., the energy and beam profile of the first laser pulse(s), timing between first and second laser pulse(s), etc.) can be chosen to ensure that the geometry of expanded corona formed in operation 206 is sufficient to achieve the desired degree of uniformity at the ablation front. As will be appreciated by the skilled artisan, computer simulations may be used to determine the desired parameters.

For the purpose of explanation and not by way of limitation, one may consider a simple scenario, as follows. Radii in this scenario are measured from a center of the target along the incident laser beam. The ablation front can be at radius r₁ in ablator layer 184, and the laser can be absorbed at radii >r₂ in corona-forming layer 182. For this example, we will also assume that thermal conductivity scales proportional to an electron temperature, T_{c}, of a material as T_{c}^{5/2} Solving for diffusive heat transport to the ablation front, it can be shown that asymmetries in heat flux at radius r₂ are smoothed by ˜(r₁/r₂)^{L+1} at a Legendre mode number of L in the exponent. Thus, a small offset between the ablation front and laser absorption (r₁/r₂˜0.9) can mitigate high-mode imperfections in the laser (L>100), while a larger standoff (r₁/r₂˜0.7) can partly offset lower modes (i.e., L<10). This calculation may be considered in this embodiment when choosing the aspect ratio of the underdense corona formed in operation 206.

Once the underdense corona has formed, the operation may be understood in one embodiment by assuming that the laser driver is absorbed uniformly from radius r₂ to r₃ in corona-forming layer 182. If the second stage of the implosion is to be spherical and symmetric, then the heat flux at the ablation front should also be substantially symmetric. By ansatz, the corona must be heated uniformly, but not necessarily by a spherical laser, nor a laser with beams impinging from a large fraction of 4π. If the incoming laser is two substantially opposed beams, as discussed above, the required laser intensity profile (versus impact parameter re, relative to axis 120) can be estimated from the intersection of these beams and the corona. As used herein, the term “substantially opposed beams” includes beams sharing a common axis and/or collinear within a few degrees. For example, the opposed beams can be collinear with a range of zero to 5 degrees, by way of example and not limitation. The incoming laser beams need to provide the same energy per unit volume at different impact parameters. For an impact parameter equal to r₂ or less, the intensity versus radius may scale as ((r₃)²−(r_{b})²)^{1/2}−((r₂)²−(r_{b})²)^{1/2}. If the impact parameter is r₂ to r₃, the intensity versus radius may scale as ((r₃)²−(r_{b})²)^{1/2}. If we assume, for example and not by way of limitation, that r₂/r₃ is in a range of 0.5 to 0.7, the resulting laser intensity may be ring-peaked (from both directions) with a maximum intensity approximately 2× higher than the average.

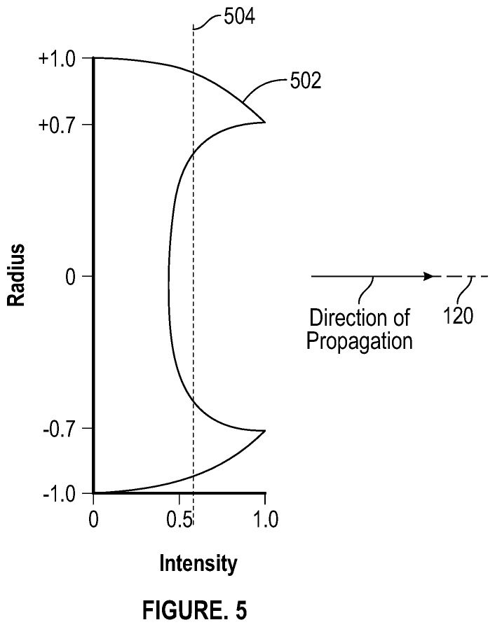

Referring to FIG. 5, at operation 208, beams emitted by asymmetric laser sources 102a and 102b in generation of the second laser pulse(s) of the second pulse set has a spatial intensity profile. The spatial intensity profile, in some embodiments, can follow the intensity profile described above. More particularly, the intensity (x-axis) versus radius (y-axis) scales such that the incoming laser beams provide the same energy per unit volume at different impact parameters. The ring-peaked intensity profile has a maximum intensity 502 that is about twice an average intensity 504 of the profile.

Based on the description above, it will be understood that energy generated and delivered by the first laser pulse(s) at operation 204 and the second laser pulse(s) at operation 208 can be absorbed, e.g., uniformly, within the corona-forming layer 182 between a radius, r₂, and a radius, r₃, from the center of the target 180. Furthermore, the ratio r₂/r₃ can be selected to facilitate spherical and symmetric implosion. For example, the ratio r₂/r₃ of the first laser pulse(s) can be in a range of 0.5 to 0.9. The ratio r₂/r₃ of the second laser pulse(s) can be in a range of 0.5 to 0.7. Accordingly, the ratio of each pulse of light in each stage may be selected to achieve an optimal implosion.

The formation of the underdense corona in operation 206 with the first laser pulse(s) generated at operation 204 is important and may be accomplished in various ways. In some embodiments, corona-forming layer 182 may be manufactured of a material which is initially underdense, and already having the aspect ratio desired. For example, corona-forming layer 182 could be manufactured using an additively printed foam lattice structure, in which the average material density (averaged over the lattice unit cell) will yield an underdense plasma once it has been heated by the first laser pulse(s) generated at operation 204. In these embodiments, the first laser pulse(s) generated at operation 204 may need only to energize the corona-forming layer 182 without significantly expanding it.

In some embodiments, corona-forming layer 182 and/or ablator layer 184 may include gradations in opacity, atomic number Z, density, mass, thickness, or other parameters to promote geometrically even absorption over corona-forming layer 182 from two-sided illumination, and the formation of a symmetric corona from the first laser pulse(s). For instance, the “poles” of the target at 0 degrees and 180 degrees in angle 188 relative to axis 120 may be designed with higher opacity, lower absorptivity, higher density, higher mass, and/or higher thickness, relative to the “equator” of the target at angle 188 of 90 degrees. Such variation in material properties may be continuous and smoothly varying between these two extremes with angle 188 or may take on stepwise variation. For example, in some embodiments, the average Z at the poles of corona-forming layer 182 may be a predetermined factor, e.g., 2, higher than the average Z of the material at the equator.

In some embodiments, this variation may be achieved by fabricating corona-forming layer 182 or ablator layer 184 using additively manufactured, graded foams. The foam cell size, composition, and/or concentration of dopant materials may be used to vary the density, average Z, or other parameters as described above. It should be understood that the optimal variation in parameters can be determined through computer simulation and/or experimental testing.

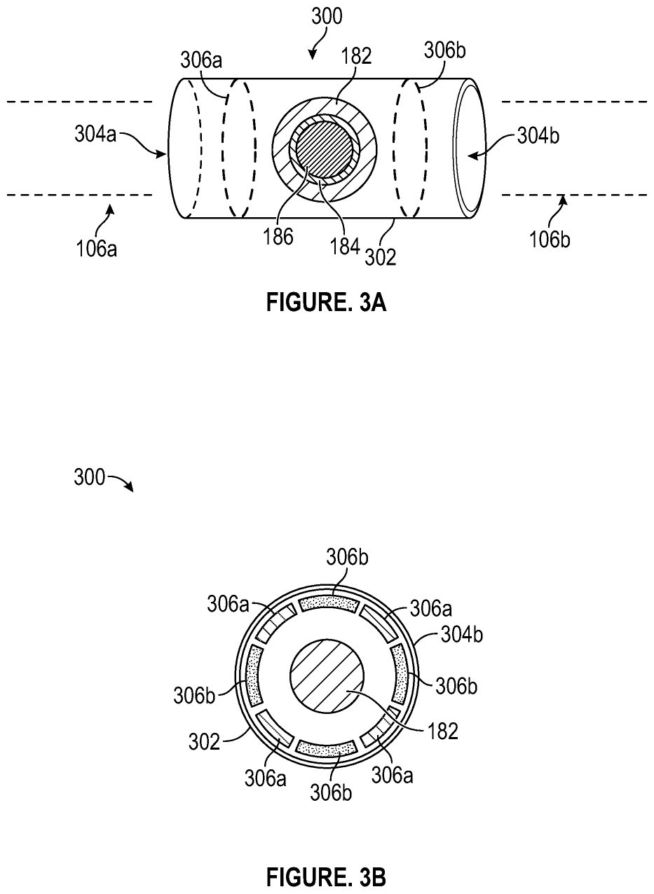

FIG. 3 illustrates another embodiment in which corona-forming layer 182 is designed to operate with hohlraum 302, forming a target 300. The target 300 can include a fuel cell, which can be used in place of target 180 as described previously. More particularly, the fuel cell can include a fusion fuel layer 186, an ablator layer 184, and a corona-forming layer 182 at least partially over the ablator layer 184. Hohlraum 302, in this embodiment, has a substantially cylindrical shape, such as a higher-Z cylinder (examples being gold, tantalum, or lead, and not by way of limitation) with open ends. For example, the hohlraum 302 can include a first open end 304a and a second open end 304b on either end of hohlraum 302, where the open ends substantially align with beam paths 106a and 106b, between the dashed lines. The hohlraum could also be a mixture of low and high atomic number materials such as (and not by way of limitation) Li—Pb with or without combinations of F, Li, or Be. Corona-forming layer 182 and enclosed ablator layer 184 and fuel layer 186 are positioned approximately in the center of hohlraum 302. The hohlraum 302 can include at least one absorbing baffle formed by a disk affixed to an interior wall. For example, the hohlraum 302 can include absorbing baffles 306a and 306b, which are two segmented disks affixed to the interior of hohlraum 302, approximately midway between hohlraum 302 center and openings 304. The absorbing baffles can be affixed to the interior wall at approximately right angles. Absorbing baffles 306a and 306b can have wedges cut out of 50% of their overall circumference in complementary locations. More particularly, the disk(s) can be segmented to remove approximately 50% of a disk cross-sectional area within a circumference of the hohlraum 302. The segmentation can therefore form several extensions from the interior wall of the hohlraum 302. As illustrated, absorbing baffles 306a have four wedges cut out of their circumference, with each wedge representing 45 degrees of arc, and separated by 45 degrees of arc from each other wedge in a rotation direction along an arc length of the arc. More particularly, each extension from the interior wall can be approximately 45 degrees of arc and separated by approximately 45 degrees of arc from an adjacent extension in a rotational direction. The rotational direction, in the case of a cylindrical hohlraum 302, can be a circumferential direction about a longitudinal axis of the cylindrical cavity. Furthermore, each baffle can be rotated by 45 degrees relative to adjacent baffles. A height of each extension, e.g., a height of each wedge, protruding in from the interior surface of hohlraum 302, can be approximately 10% of the radius of the hohlraum 302 cylinder. More particularly, the height of each extension from the interior wall can be approximately 10% of a radius of an interior cylindrical cavity of the hohlraum 302. Furthermore, baffles 306a and 306b are rotated 45 degrees with respect to each other around the long axis of hohlraum 302. FIG. 3A shows a side view of target 300 and hohlraum 302, and FIG. 3B shows a view looking through open end 304b at the components inside hohlraum 302.

In operation of this embodiment, laser sources 102a and 102b are configured to generate wedge-shape patterns in the first laser pulse(s) generated at operation 204 that correspond to the shape and alignment of baffles 306a and 306b. Laser source 102a is configured to send a beam through open end 304a, and then through the open wedge sections of absorbing baffle 306a, to illuminate and be absorbed on baffle 306b. Correspondingly, laser source 102b illuminates baffle 306a by propagating through open sections of baffle 306b. The complementary nature of baffles 306a and 306b ensures that these baffles can be illuminated on their interior surface (relative to target 300) even by collinear or nearly collinear beams from beam paths 106a and 106b. The energy of the first laser pulse(s) generated at operation 204 is absorbed in baffles 306a and 306b, and then re-emitted as an x-ray field which fills hohlraum 302. This x-ray field interacts with corona-forming layer 182, producing a symmetric expanded corona in hohlraum 302. Laser sources 102a and 102b are configured to fire the second laser pulse(s) of the second pulse set in the second stage, in a pattern now corresponding to a spot focused on the expanded corona. In this embodiment the pattern may involve the intensity profile described above. The laser energy absorbed in the expanded corona is then smoothed by electron thermal conduction as described above, and may lead to a symmetric ablation front in ablator layer 184 and symmetric implosion of fuel layer 186.

While in this embodiment absorbing baffles 306a and 306b are shown in four 45-degree sections separated by 45 degrees of arc, though other configurations are possible and may lead to better uniformity, such as six 30-degree sections separated by 30 degrees of arc, or twelve 15-degree sections separated by 15 degrees of arc, etc.

Absorbing baffles height, thickness, and other parameters may vary from the pattern described here and may be optimized by computer simulation or experimental testing.

In another embodiment illustrated in FIG. 4, the corona-forming layer 182 and ablator layer 184 are manufactured as a single integral component in target 180, without a definite boundary between them. The corona-forming layer 182 and ablator layer 184 are shimmed in thickness with angle 188 relative to polar axis 120, having the lowest thickness near the equatorial plane 402, and having the highest thickness near the polar axis 120. Accordingly, the corona-forming layer 182 and the ablator layer 184 can have graded thicknesses with respect to the polar axis 120, with lower thicknesses near the equatorial plane 402 and larger thickness near the polar axis 120. This asymmetry in thickness may offset any remaining low-order asymmetry from laser energy deposition into the corona-forming layer 182 and/or ablator layer 184. This configuration of corona-forming layer 182 and ablator layer 184 may also be used in combination with the hohlraum 302 described previously.

The targets and systems disclosed here may be considered counterintuitive compared to conventional designs, as the symmetry properties may appear poorer than existing systems which are typically designed to achieve a symmetric and uniform implosion, but with lower overall hydrodynamic efficiency. However, the advantages of the invention may be clear in a full consideration of the cost and complexity of an integrated system involving a target, laser, and chamber, in which the cost of the system may scale with the number of independent beam sources and beam penetrations in the chamber wall. Embodiments of this invention may provide a mechanism to achieve symmetric implosion of an inertial fusion target in systems involving a limited number of beam penetrations.

It should be understood by those skilled in the art that the embodiments described herein are for exemplary purposes and should not be considered to limit the scope of the invention to only the specific examples or combinations listed. Embodiments of the invention may not contain all the characteristics listed, and not all possible combinations of characteristics or features are enumerated.

What is claimed is:

1. A system for inertial confinement fusion, comprising:
a target with a fusion fuel layer, an ablator layer, and a corona-forming layer;
at least one laser source configured to illuminate the target with two substantially opposed beams in a first pulse set followed by a second pulse set to result in ignition of the fusion fuel layer.

2. The system according to claim 1, wherein the two substantially opposed beams each comprise a plurality of beams overlapped in a small solid angle.

3. The system according to claim 2, wherein the small solid angle is less than 0.1% of 4π.

4. The system according to claim 1, wherein the first pulse set illuminates the corona-forming layer to form an expanded corona, and wherein the second pulse set includes a plurality of second laser pulses to energize the expanded corona.

5. The system according to claim 4, wherein energizing the expanded corona by the second pulse set includes illuminating the expanded corona to produce a substantially uniform pressure profile on the ablator layer and the fusion fuel layer.

6. The system according to claim 5, wherein the target is inside a hohlraum.

7. The system according to claim 5, wherein the first pulse set delivers energy absorbed uniformly between a radius, r₂, and a radius, r₃, from a center of the target, and wherein r₂/r₃ is in a range of 0.5 to 0.9.

8. The system according to claim 5, wherein the second pulse set delivers energy uniformly between a radius, r₂, and a radius, r₃, from a center of the target, and wherein r₂/r₃ is in a range of 0.5 to 0.7.

9. The system according to claim 5, wherein one or more of the corona forming layer or the ablator layer have gradations in one or more of opacity, atomic number, density, or thickness.

10. A method of inertial confinement fusion, comprising:
delivering a first pulse set including a first laser pulse to a target comprised of a fusion fuel layer, an ablator layer, and a corona-forming layer, wherein the first laser pulse delivers energy in a first set of two substantially opposed beams;
delivering a second pulse set including one or more second laser pulses following the first laser pulse to result in ignition of the fusion fuel layer, wherein the second pulse set delivers energy in a second set of two substantially opposed beams.

11. The method of claim 10, wherein the first set of two substantially opposed beams and the second set of two substantially opposed beams each comprise a plurality of beams overlapped in a small solid angle.

12. The method according to claim 11, wherein the small solid angle is less than 0.1% of 4π.

13. The method according to claim 10, wherein the first pulse set illuminates the corona-forming layer to form an expanded corona, and wherein the second pulse set includes a plurality of second laser pulses to energize the expanded corona.

14. The method according to claim 10, wherein the second pulse set illuminates the expanded corona to produce a substantially uniform pressure profile on the ablator layer and the fusion fuel layer.

15. A target for inertial confinement fusion, the target comprising:
a fusion fuel layer;
an ablator layer at least partially over the fusion fuel layer;
a corona-forming layer at least partially over the ablator layer;
wherein the corona-forming layer and the ablator layer are integral with each other without a definite boundary.

16. The target according to claim 15, wherein the corona-forming layer and the ablator layer have graded thicknesses with respect to a polar axis, with lower thicknesses near an equatorial plane and larger thickness near the polar axis.

17. The target according to claim 16, wherein the corona-forming layer and the ablator layer include high-Z materials, and wherein the corona-forming layer and the ablator layer are graded in one or more of density or opacity with respect to the polar axis.

18. A target for inertial confinement fusion, the target comprising:
a hohlraum having a substantially cylindrical shape, the hohlraum comprising
a first open end and a second open end,
an interior wall,
at least one absorbing baffle formed by a disk affixed to the interior wall at approximately right angles, wherein the disk is segmented to remove approximately 50% of a disk cross-sectional area within a circumference of the hohlraum to form a plurality of extensions from the interior wall; and
a fuel cell suspended in the hohlraum, wherein the fuel cell comprises a fusion fuel layer, an ablator layer at least partially over the fusion fuel layer, and a corona-forming layer at least partially over the ablator layer.

19. The target according to claim 18, wherein a height of each extension from the interior wall is approximately 10% of a radius of an interior cylindrical cavity.

20. The target according to claim 18, wherein each extension from the interior wall is approximately 45 degrees of arc and separated by approximately 45 degrees of arc from an adjacent extension in a rotational direction.

21. The target according to claim 18, wherein each extension from the interior wall is approximately 45 degrees of arc and separated by approximately 45 degrees of arc from an adjacent extension, and wherein each baffle is rotated by 45 degrees relative to adjacent baffles.
